(19) United States
(12) Patent Application Publication
(10) Pub. No.: US 2013/0111103 A1
(43) Pub. Date: May 2, 2013

(54) HIGH-SPEED SYNCHRONOUS WRITES TO PERSISTENT STORAGE

(71) Applicants: John S. Dodson, Pflugerville, TX (US); Randal C. Swanberg, Round Rock, TX (US)

(72) Inventors: John S. Dodson, Pflugerville, TX (US); Randal C. Swanberg, Round Rock, TX (US)

(73) Assignee: INTERNATIONAL BUSINESS CORPORATION, Armonk, NY (US)

(21) Appl. No.: 13/283,956

(22) Filed: Oct. 28, 2011

(51) Int. Cl. G06F 12/02; G06F 12/16; G06F 12/06

(52) U.S. Cl. 711/103; 711/105; 711/162; 711/E12.008; 711/E12.078; 711/E12.103

(57) ABSTRACT

A memory configured to provide a write requestor with a direct write programming interface to a disk device. A first persistent memory is configured for designating at least a portion its memory locations as central processing unit (CPU) load storable memory. The first persistent memory is also configured for receiving write data from the write requestor, for storing the write data in the CPU load storable memory, and for returning a write completion message to the write requestor in response to the storing completing. The memory also includes a second persistent memory that includes the disk device, and a controller in communication with the first and second persistent memories. The controller is configured for detecting the storing of the write data to the CPU load storable memory and for copying the write data to the second persistent memory in response to detecting the storing of the write data.

### BACKGROUND

The present invention relates to a data processing system, and more specifically, to high-speed synchronous writes to persistent storage in a data processing system.

Overall computer system performance is affected by each of the key elements of the structure of the computer system, including the performance/structure of the processor(s), any memory cache(s), the input/output (I/O) subsystem(s), the efficiency of the memory control function(s), the main memory device(s), and the type and structure of the memory interconnect interface(s).

High-availability computer systems present challenges related to overall system reliability due to customer expectations that new computer systems will markedly surpass existing systems in regard to mean-time-between-failure (MTBF), in addition to supporting additional functions, increased performance, increased storage, lower operating costs, etc. Other frequent customer requirements further exacerbate design challenges, and include such items as ease of upgrade and reduced system environmental impact, such as space, power, and cooling.

Most contemporary computer systems perform some type of logging to store data for use, for example, during restart and/or recovery processing. Typically, logging is performed in a synchronous manner and the operation of the application requesting the logging is interrupted until an I/O to write the log data to persistent storage is completed by an I/O subsystem. The processor initiates a write command to an I/O subsystem and suspends operation of the application until the processor receives a notification that the write command has completed.

### SUMMARY

An embodiment is a system that includes a memory configured to provide a write requestor with a direct write programming interface to a disk device. The memory includes a first persistent memory that includes memory locations and that is configured for designating at least a portion of the memory locations as central processing unit (CPU) load storable memory. The first persistent memory is also configured for receiving write data from the write requestor, for storing the write data in the CPU load storable memory, and for returning a write completion message to the write requestor in response to the storing completing. The memory also includes a second persistent memory that includes the disk device, and a controller in communication with the first persistent memory and the second persistent memory. The controller is configured for detecting the storing of the write data to the CPU load storable memory in the first persistent memory. The controller is also configured for copying the write data to the second persistent memory in response to detecting the storing of the write data.

Another embodiment is a method that includes providing a write requestor with a direct write programming interface to a disk device. The providing includes designating at least a portion of a first persistent memory as CPU load storable memory, receiving write data from the write requestor, and storing the write data into the CPU load storable memory. A write completion message is returned to the write requestor in response to the storing completing. The storing of write data to the CPU load storable memory is detected by a controller that is in communication with the first persistent memory and a second persistent memory. The second persistent memory includes the disk device. The write data is copied to a predetermined location in the second persistent memory in response to the detecting. The copying is performed by the controller and is in response to the detecting.

A further embodiment is a computer program product that includes a tangible storage medium readable by a processing circuit and storing instructions for execution by the processing circuit for performing a method. The method includes providing a write requestor with a direct write programming interface to a disk device. The providing includes designating at least a portion of a first persistent memory as CPU load storable memory, receiving write data from the write requestor, and storing the write data into the CPU load storable memory. A write completion message is returned to the write requestor in response to the storing completing. The storing of write data to the CPU load storable memory is detected by a controller that is in communication with the first persistent memory and a second persistent memory. The second persistent memory includes the disk device. The write data is copied to a predetermined location in the second persistent memory in response to the detecting. The copying is performed by the controller and is in response to the detecting.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a system for implementing synchronous logging in accordance with an embodiment;

FIG. 2 depicts a process flow for performing synchronous logging in accordance with an embodiment;

FIG. 3 is a block diagram of a system configuration with a log device interface that is hidden from an application in accordance with an embodiment;

FIG. 4 is a block diagram of a system configuration with a log device interface that is exposed to an application in accordance with an embodiment; and

FIG. 5 depicts a log device interface in accordance with an embodiment.

### DETAILED DESCRIPTION

High-speed synchronous writes to persistent storage are performed in accordance with exemplary embodiments described herein. A new programming model is used to accelerate the speed of synchronous writes of data, such as log data, to persistent storage.

Contemporary implementations of persistent storage may be characterized by aspects such as persistence, programming model, latency of write completion, and capacity. In terms of persistence, records of activity that need to be saved to persistent storage (e.g., log data) may be saved to mediums such as non-volatile (battery backed) dynamic random access memory (DRAM), flash memory (e.g., solid state drive or “SSD”), magnetic disk (e.g., hard disk drive or “HDD”), or tape. Non-volatile DRAM provides the lowest latency of write completion because it is directly byte-storable by a central processing unit (CPU). However, non-volatile DRAM is not practical for the persistent storage of large volumes of data (e.g., gigabytes or terabytes of persistently maintained logs, records, etc.). In addition, non-volatile DRAM only provides temporal persistence (i.e., until the battery dies, or capacitance is lost). Disk devices, such as SSD and HDD do provide the needed capacities for large volumes of data and they are characterized by long term persistence. However, when compared to non-volatile DRAM, disk devices have a longer path length of programming and longer latency of write completion. This is because disk devices are not byte addressable and they require programming of a controller that then manages block transfers (via direct memory access or “DMA”) from the host memory to the device.

Embodiments described herein provide persistent storage that is a mix of non-volatile DRAM and flash memory (SSD) to provide both lower latency and simplified programming (e.g., using a direct CPU store) with disk capacities that support large volumes of data. Embodiments described herein include a new programming model for existing SSDs (or other type of disk devices) that maximizes the performance of applications that require confirmation that synchronous writes to disk have completed (e.g., for integrity, reliability) before continuing on to the next instruction(s). From the perspective of a write requestor (e.g., an application, a device driver), the new programming model provides a direct write programming interface (e.g., memory mapped CPU byte stores) to a disk device.

In an embodiment, the persistent storage includes both a non-volatile (DRAM) and a flash memory. Instead of the programming model requiring block input/output (I/O) write setup through a disk controller, all or a portion of the DRAM is memory mapped and made direct CPU store addressable to an application program. The DRAM is made non-volatile by providing battery backup or simply by containing enough capacitance that it is guaranteed to support draining to the flash memory. In one embodiment, the non-volatile DRAM is remapped to correspond to a different range of flash memory logical blocks on demand. In another embodiment, the non-volatile DRAM is used in a circular buffer fashion by updating start and end pointers within the buffer for new writes, and as soon as the pointers are updated, the contents are spilled to the flash memory. This allow the application program to perform its writes (e.g., log data writes) to persistent storage, at CPU store speed to memory, without having to make a system call to the operating system to initiate an I/O operation and await completion. As soon as the CPU stores are completed, the log data write is complete and in persistent storage, and the application program can continue processing.

Embodiments described herein eliminate performance and throughput bottlenecks that may be caused by contemporary methods for performing synchronous writes to persistent storage. Embodiments may be used for application scenarios that require some amount of data to be written synchronously and require acknowledgement that the write has completed successfully into persistent storage prior to the application continuing. Examples include, but are not limited to database logs, file system journal logs, intent logs, security logs, and compliance audit logs. Another example is trace files that capture application/operating system (OS) execution paths/history for performance or first-failure-data-capture analysis.

As used herein, the term “synchronous store” or “synchronous write” refers to a store, or write, operation that must be completed to persistent memory before the application requesting the store operation can initiate the next instruction in the application.

As used herein, the term “persistent data” refers to data that will exist after execution of the program has completed. As used herein, the term “persistent storage” refers to a storage device (e.g., a non-volatile DRAM, a disk drive, a flash drive, etc.) where persistent data is stored.

As used herein, the term “non-volatile DRAM” refers to a DRAM that retains its data when the power is turned off. In an embodiment, the DRAM is only required to retain its data after a power interruption long enough to ensure that all its contents can be written to the backing persistent memory (e.g., flash memory).

As used herein, the term “memory mapped” or “memory mapped file” refers to a segment of virtual memory which has been assigned a direct byte-for-byte correlation with some portion of the non-volatile DRAM and that can be referenced by the OS through a file descriptor. Once present, this correlation between the non-volatile DRAM and the memory space in the virtual memory permits applications executing on a CPU to treat the mapped portions as if they are primary memory. Memory mapped storage is an example of a CPU load storable memory. Programmed I/O (PIO) is an example of a method of transferring data between the applications and the memory mapped portions of the non-volatile DRAM. In PIO, the CPU (or application executing on the CPU) is responsible for executing instructions that transfer data to/from the non-volatile DRAM at the memory mapped locations. The term “memory mapped I/O” or “MMIO” refers to I/O that is accessible via CPU loads/stores in order to transfer data from/to and I/O device. Thus, the terms MMIO and PIO refer to the same thing are used herein interchangeably. PIO and MMIO are contrasted with direct memory access (DMA) where a subsystem(s) within a processor accesses system memory located on a storage device independently of the CPU. With DMA, the CPU initiates a data store, performs other operations while the transfer is in process, and receives an interrupt from the DMA controller once the operation has been completed. Once the CPU receives the interrupt, the application requesting the synchronous data store can continue processing.

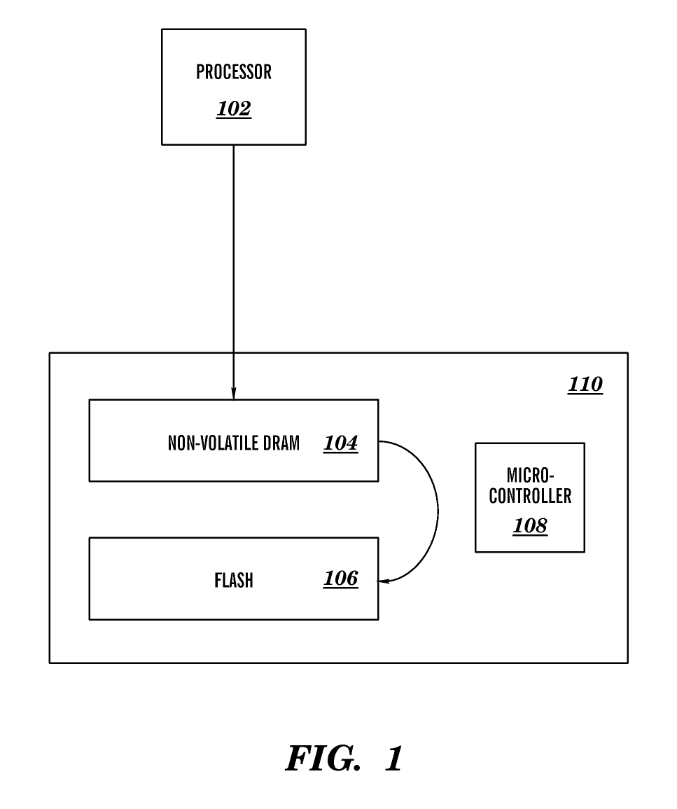

FIG. 1 is a block diagram of a system for implementing synchronous logging in accordance with an embodiment. The system shown in FIG. 1 includes a processor 102 and a memory system 110. The memory system 110 includes a non-volatile DRAM 104, a flash memory 106, and a micro-controller 108. In an embodiment, all or a portion of the non-volatile DRAM 104 is memory mapped and is CPU store addressable to an application running on the processor 102. An application executing on the processor 102 writes data to the non-volatile DRAM 104 and contents of the non-volatile DRAM are periodically copied, or spilled, to the flash memory 106. Once the application has completed writing data to the non-volatile DRAM 104, the data is in persistent memory and the application continues processing. This allows the application to perform synchronous stores at memory speed to persistent storage. Periodically (e.g., in response to receiving write data), the micro-controller 108 initiates spilling the contents of the non-volatile DRAM 104 to the flash memory 106. The micro-controller 108 copies the contents of the non-volatile DRAM 104 to the flash memory. In an embodiment, the copying is performed with simple spill logic. This allows the application to be in direct control of the DRAM mapping to backing store (flash), with the application giving explicit instructions to the controller. This is contrasted with contemporary methods where a controller manages the DRAM as a least recently used (LRU) cache (i.e., demand paging). In general, the speed of the periodic copying of the contents of the non-volatile DRAM 104 to the flash memory 106 is not performance critical because the application is not waiting for the copying to be completed, but instead continues processing a next instruction once the data is written to the non-volatile DRAM 104.

In an embodiment, elements (i.e., the non-volatile DRAM 104, flash memory 106 and micro-controller 108) of the memory system 110 shown in FIG. 1 are located in a single location, such as on a memory module or a peripheral component interconnect express (PCIe) adapter In another embodiment, the elements are located in one or more different locations (e.g., the micro-controller 108 is located in a memory controller or in the processor 102, and the non-volatile DRAM 104 and flash memory 106 are located on a PCI-e adapter). In a further embodiment, the functionality provided by the micro-controller 108 is embedded into a memory controller and/or the processor 102. The micro-controller 108 may be implemented by hardware, software, and/or firmware.

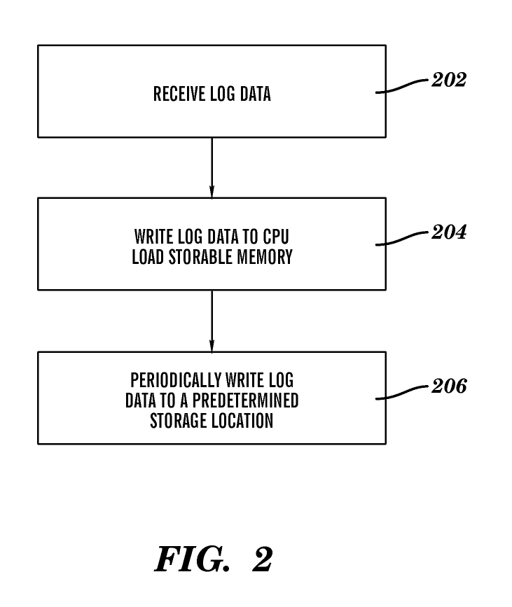

Referring to FIG. 2, a process flow for performing synchronous logging in accordance with an embodiment is generally shown. In an embodiment, the process shown in FIG. 2 is performed by a combination of the processor 102 and the micro-controller 108 shown in FIG. 1. At block 202, a segment of log data (e.g., log data associated with a write to log command) is received from an application program. The segment of log data is written to a CPU load storable memory (e.g., memory mapped non-volatile DRAM 104) at block 204. At block 206, the log data is periodically copied (e.g., by the microcontroller 108) from the CPU load storable memory to a predetermined storage location (e.g., the flash memory 106). In an embodiment, the copying overlaps with the writing of the segment of log data to the CPU load storable memory. In another embodiment, the copying is initiated in response to the writing of the segment of log data to the CPU load storable memory being completed. In a further embodiment, the copying is initiated in response to a number of bytes in the CPU load storable memory reaching a programmable threshold.

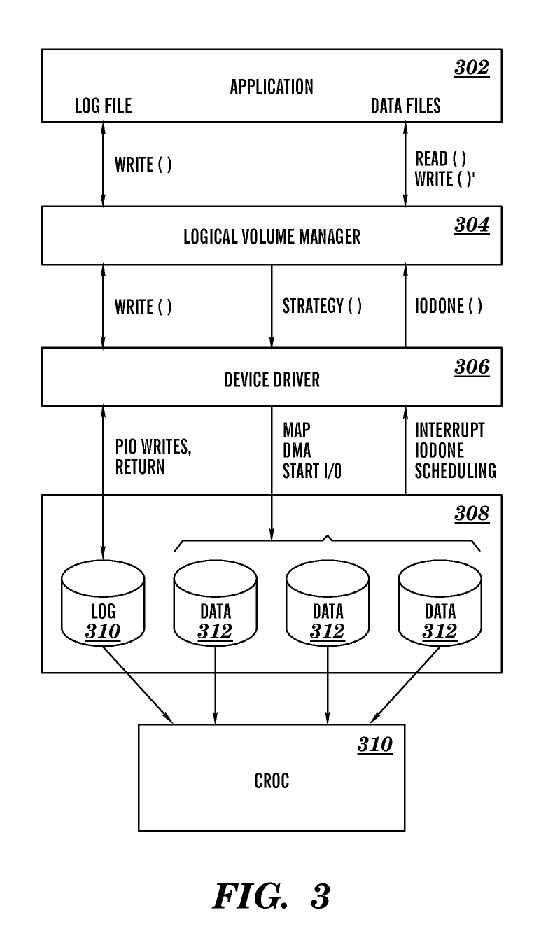

FIG. 3 is a block diagram of a system configuration with a log device interface that is hidden from an application in accordance with an embodiment. As shown in FIG. 3, the application makes a system call to perform the disk write as normal (the application does not know the difference), but within the OS stack (i.e., the device driver) an embodiment described herein is leveraged by avoiding issuing an asynchronous I/O to the device. Instead, the write is completed synchronously and control is returned directly to the application without needing to block the application (i.e., remove the application from the CPU) awaiting I/O completion. The left side of FIG. 3 depicts a CPU store that is addressable to the device driver 306 and the right side of FIG. 3 depicts a typical DMA block I/O write setup through the device driver 306, or disk controller.

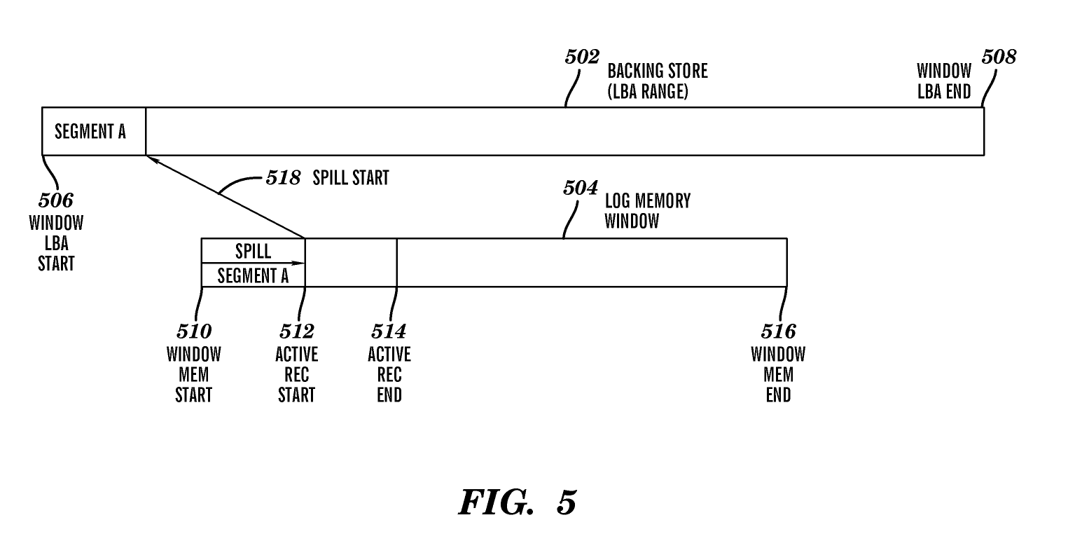

The system in FIG. 3 includes an application 302 executing on a CPU, a logical volume manager 304, the device driver 306, and logical volumes 308. In the system configuration shown in FIG. 3, the DRAM memory is memory mapped to the device driver 306 to avoid having to make changes to the application 302. In an embodiment, the application 302 is implemented, for example, using application middleware or a file system executing on a processor, such as processor 102. In an embodiment, the application 302, the logical volume manager 304, and the device driver 306, all execute on the host processor 102, and they interface with the micro-controller 108 via memory mapped PIO CPU stores to the various control pointers shown in FIG. 5. In an embodiment, the logical volumes 308 (e.g., memory device, adapter) are located in the memory subsystem 110, and the log device 310 includes the non-volatile DRAM 104 and the flash memory 106 shown in FIG. 1.

The right side of FIG. 3 illustrates a typical synchronous command/DMA/interrupt interface where the application 302 requests a write of write data to the logical volume manager 304 and then the application 302 is taken off of the processor and put into a queue waiting for the write to complete. The logical volume manager 304 in the I/O subsystem determines the logical volume 412 to be written to with the write data and sends this information to the device driver 306. The device driver 306 knows which physical device corresponds to the logical volume 412 using a map DMA and the device driver starts an I/O to the device. Once the write is complete, an interrupt and I/O done scheduling message is sent to the device driver 306, which passes the message to the logical volume manager 304, which passes the message to the manager of the queue where the application 302 is being held. At this point, the application 302 may be re-enqueued to be dispatched on a host processor to continue executing.

The left side of FIG. 3 depicts an embodiment of the present invention where a CPU store is addressable to the device driver 306. As shown on the left side of the system configuration in FIG. 3, an application 302 constructs a specific log type logical file (referred to herein as a log device 310) backed by a special logical block address (LBA) range with the log device 310 having a synchronous PIO write interface. In an embodiment, the non-volatile DRAM 104 of FIG. 1 is used to implement the portion of the log device 310 that is memory mapped and the flash memory 106 of FIG. 1 is used to implement the non-memory mapped portions of the log device 310. The application 302 opens/writes to the log device 310 as normal (without any changes to the application 302) via the logical volume manager 304. The device driver 306 recognizes that the write is to the special memory mapped LBA range. In response to recognizing that the write is to the LBA range, the device driver 306 performs a synchronous PIO to the log device 310 and returns an I/O completion. In this manner, a new synchronous PIO window interface is utilized to write the log data to the log device 310, where as soon as the CPU stores are complete, the log data write is complete and in persistent storage, and the application can continue processing.

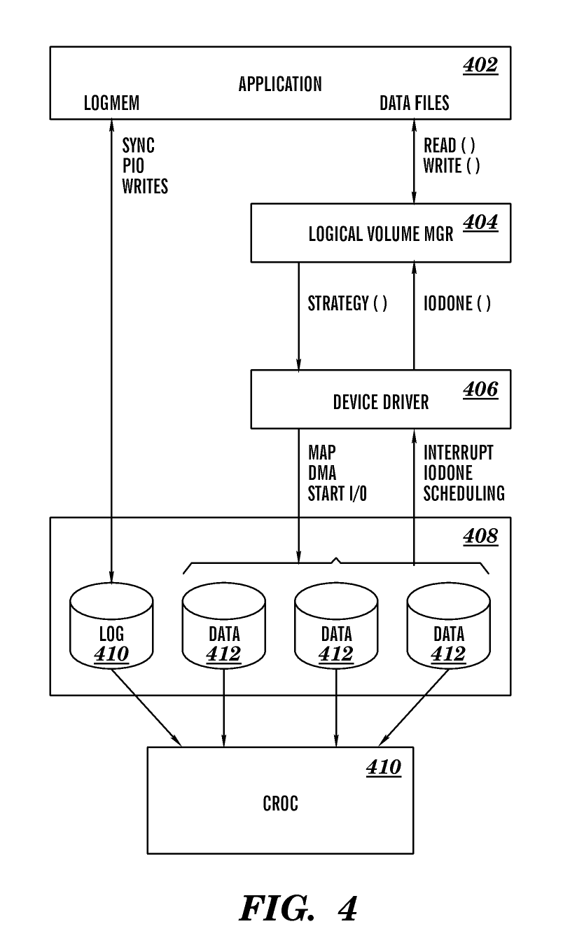

FIG. 4 is a block diagram of a system with a log device interface that is exposed to an application in accordance with an embodiment. The left side of FIG.4 depicts a CPU store addressable to an application 402 and the right side of FIG.4 depicts a typical DMA block I/O write setup through a device driver 306, or disk controller.

The system in FIG. 4 includes the application 402 executing on a CPU, a logical volume manager 404, the device driver 406, and logical volumes 408. In the system configuration shown in FIG. 4, the DRAM memory is memory mapped to the application 402. In an embodiment, the application 402 is implemented, for example, using application middleware or a file system executing on a processor, such as processor 102. In an embodiment, the application 402, the logical volume manager 404, and the device driver 406 all execute on the host processor 102 and they interface with the micro-controller 108 via memory mapped PIO CPU stores to the various control pointers shown in FIG. 5. In an embodiment, the logical volumes 408 (e.g., memory device, adapter) are located in the memory subsystem 110, and the log device 410 includes the non-volatile DRAM 104 and the flash memory 106 shown in FIG. 1.

The right side of FIG. 4 is similar to the right side of FIG. 3. It illustrates a typical synchronous command/DMA/interrupt interface where the application 402 requests a write of write data to the logical volume manager 404 and then the application 402 is taken off of the processor and put into a queue waiting for the write to complete. The logical volume manager 404 in the I/O subsystem determines the logical volume 412 to be written to with the write data and sends this information to the device driver 406. The device driver 406 knows which physical device corresponds to the logical volume 412 using a map DMA and the device driver starts an I/O to the device. Once the write is complete, an interrupt and I/O done scheduling message is sent to the device driver 406, which passes the message to the logical volume manager 404, which passes the message to the manager of the queue where the application 402 is being held. At this point, the application 402 may be re-enqueued to be dispatched on a host processor to continue executing.

The left side of FIG. 4 depicts an embodiment of the present invention where a CPU store is addressable to the application 402. As shown on the left side of the system configuration in FIG. 4, an application 402 directly memory maps (e.g., with operating system safeguards and/or assistance) a log window of a log device 410. In an embodiment, the non-volatile DRAM 104 of FIG. 1 is used to implement the portion of the log device 410 that is memory mapped and the flash memory 106 of FIG. 1 is used to implement the non-memory mapped portions of the log device 410. The application 402 stores directly into log memory in the memory mapped portions of the non-volatile DRAM 104. The application 402 recognizes that a write to the log is to the log window. In response to recognizing that the write is to the log window, the application 402 performs a synchronous PIO to the log device 410 and returns an I/O completion. In this manner, a new synchronous PIO window interface is utilized to write the log data to the log device 410, such that as soon as the CPU stores are complete, the log data write is complete and in persistent storage, and the application can continue processing. This method of writing log data is referred to herein as high-speed because the log data is stored without having to make a system call to the operating system to initiate an I/O operation and await completion. The embodiment shown in FIG. 4 represents a lower latency than the embodiment shown in FIG. 3 because a system call is not required in order to store the data.

In the embodiment shown in FIG. 4, the application 402 manages log window pointers and control pointers for use in accessing the log window of the log device 410 (see FIG. 5). In the embodiment shown in FIG. 4, the application 302 requires additional code to perform the synchronous PIO writes shown in FIG. 4. A new library application programming interface (API) may be provided to abstract the programming details. This is contrasted with the scenario shown in FIG. 3 where the programming sequence is performed by the device driver 306. In both scenarios, the application never has to enter the kernel to accomplish a disk write.

Referring to FIG. 5, a backing store 502 and a log memory window 504 in accordance with exemplary embodiments are generally shown. In an embodiment, the log memory window 504 is located on a non-volatile DRAM (e.g., non-volatile DRAM 104 as shown in FIG. 1) and the backing store 502, which corresponds to an LBA range, is located on a flash memory device (e.g., flash memory 106 as shown in FIG. 1). In an embodiment, the backing store 502 is configured by the flash memory device, and the log memory window is memory mapped and managed by a device driver and/or application.

The window LBA start pointer 506 points to the starting location of the backing store 502 and the window LBA end pointer 508 points to the last location in the backing store 502. In an embodiment, both the LBA start pointer 506 and the LBA end pointer 508 are stored as programmable entities (e.g., stored in a register or memory location on the flash memory device) that are programmed as part of system initialization when the LBA range for the log device is initially being “carved out” and allocated for use as the logical disk (i.e., log device 310 in FIG. 3, log device 410 in FIG. 4).

The window memory start pointer 510 points to the beginning location of the log memory window 504 (the start of the memory mapped portion of the non-volatile DRAM) and the window memory end pointer 516 points to the ending location of the log memory window 504 (the end of the memory mapped portion of the non-volatile DRAM). In an embodiment, both the window memory start pointer 510 and the window memory end pointer 516 are stored as programmable entities (e.g., stored in a register or memory location on the DRAM device) that are programmed as part of system initialization time to define the circular DRAM buffer where the application or device driver will write the data to. The locations between the active record start pointer 512 and the active record end pointer 514 are the locations in the log memory window 504 where the next segment of log data, received via the PIO window interface, will be stored. In an embodiment, the terms “write segment” or “log segment” refers to data bits that are written to the log by a single write command from an application. The spill start pointer 518 points to the location in the backing store 502 where the next log segment will be stored when the log segment is copied from the log memory window 504 to the backing store 502. Also shown in FIG. 5 is “segment A” which was previously copied from the log memory window 504 to the backing store 502.

Following is a process for performing a log write using the backing store 502 and the log memory window 504 shown in FIG. 5 in accordance with an embodiment. This process is performed during run time (i.e., during the normal operation of writing data to the log device) and will be performed by either an application (for embodiment shown in FIG. 4) or device driver (for embodiment shown in FIG. 3). In an embodiment, a MMIO store is performed to create an active record allocation in the non-volatile DRAM as denoted by the space between the active record start pointer 512 and the active record end pointer 514. Next, one or more MMIO stores are performed to write the log data (number of MMIO stores depends on the size of the log data and the width of the MMIO stores) to the non-volatile DRAM in the space corresponding to the active record. A MMIO store is then performed to move the active record start pointer 512 from its current location to the location pointed to by the active record end pointer 514. Thus, both the active record start pointer 512 and the active record end pointer 514 now point to the same location, the location where the next record will be written. The above process is performed on a host processor, such as processor 102 in FIG. 1.

As shown in FIG. 5, another process is being performed by a device, such as memory system 110 in FIG. 1, under control of a controller, such as microcontroller 108 in FIG. 1. In an embodiment, the controller has its own internal state/pointer (not shown) that points to its next spill location in the non-volatile DRAM buffer. The controller monitors the pointer that points to its next spill location and the active record start pointer 512. As long as these are equal, the controller is idle. When the controller detects that they are no longer equal (i.e., the processor has moved the active record start pointer 512 to indicate that another record has been written to the DRAM), the controller then starts spilling the data from the non-volatile DRAM. The controller spills data from the next spill pointer up to the active record start pointer 512 and then updates the next spill pointer as the data is being written. The data is written to the backing store 502 starting at the location pointed to by the spill start pointer 518. When the write is complete, the controller also updates the spill start pointer 518 to point to the next backing store spill location.

In an embodiment the host processor (e.g., the application or the device driver) and/or the controller must check for and compensate for buffer wrap whenever updating/moving their respective pointers forward. In an embodiment, the controller is also responsible for enforcing that the backing store spill location can't go beyond the window LBA end pointer 508.In another embodiment, the non-volatile DRAM is remapped to correspond to a different range of flash memory logical blocks on demand. In this embodiment, the spill start pointer 518 also becomes an element that is programmable by the host processor. As a start of each new disk write, the host processor programs a new starting location in the backing store 502 for the next write. A MMIO store is performed to store the desired spill start pointer 518 value prior to moving the active record start pointer 512 from its current location to the location pointed to by the active record end pointer 514 as described in the previous example. As described previously, moving the active record start pointer 512 triggers the controller to initiate the write from the log memory window 504 on the non-volatile DRAM to the a spill location on the backing store 502.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A system comprising:
a memory configured to provide a write requestor with a direct write programming interface to a disk device, the memory comprising:
a first persistent memory comprising memory locations, the first persistent memory configured for designating at least a portion of the memory locations as central processing unit (CPU) load storable memory, for receiving write data from the write requestor, for storing the write data in the CPU load storable memory, and for returning a write completion message to the write requestor in response to the storing completing;
a second persistent memory comprising the disk device; and
a controller in communication with the first persistent memory and the second persistent memory, the controller configured for detecting the storing of the write data to the CPU load storable memory in the first persistent memory, and for copying the write data to the second persistent memory, the copying responsive to the detecting.

2. The system of claim 1, wherein the storing is a synchronous data store.

3. The system of claim 1, wherein the first persistent memory is a non-volatile dynamic random access memory (DRAM).

4. The system of claim 1, wherein the write requestor is an application executing on a processor, the CPU load storable memory is memory mapped to the application, and the write data is received directly from the application.

5. The system of claim 1, wherein the write requestor is a device driver, the CPU load storable memory is memory mapped to the device driver, and the write data is received directly from the device driver.

6. The system of claim 1, wherein the disk device is a flash memory.

7. The system of claim 1, wherein the write data is log data.

8. The system of claim 1, wherein the copying the write data to the second persistent memory is performed using spill logic.

9. A method comprising:
providing a write requestor with a direct write programming interface to a disk device, the providing comprising:
designating at least a portion of a first persistent memory as central processing unit (CPU) load storable memory;
receiving write data from the write requestor;
storing the write data into the CPU load storable memory;
returning a write completion message to the write requestor in response to the storing completing;
detecting the storing of the write data to the CPU load storable memory, the detecting performed by a controller in communication with the first persistent memory and a second persistent memory, the second persistent memory comprising the disk device; and
copying the write data to a predetermined location in the second persistent memory responsive to the detecting, the copying performed by the controller and responsive to the detecting.

10. The method of claim 9, wherein the storing is a synchronous data store.

11. The method of claim 9, wherein the first persistent memory is a non-volatile dynamic random access memory (DRAM).

12. The method of claim 9, wherein the write requestor is an application executing on a processor, the CPU load storable memory is memory mapped to the application, and the write data is received directly from the application.

13. The method of claim 9, wherein the write requestor is a device driver, the CPU load storable memory is memory mapped to the device driver, and the write data is received directly from the device driver.

14. The method of claim 9, wherein the disk device is a flash memory.

15. The method of claim 9, wherein the write data is log data.

16. The method of claim 9, wherein the copying the write data to the second persistent memory is performed using spill logic.

17. A computer program product comprising:
a tangible storage medium readable by a processing circuit and storing instructions for execution by the processing circuit for performing a method comprising:
providing a write requestor with a direct write programming interface to a disk device, the providing comprising:
designating at least a portion of a first persistent memory as central processing unit (CPU) load storable memory;
receiving write data from the write requestor;
storing the write data into the CPU load storable memory;
returning a write completion message to the write requestor in response to the storing completing;
detecting the storing of the write data to the CPU load storable memory, the detecting performed by a controller in communication with the first persistent memory and a second persistent memory, the second persistent memory comprising the disk device; and
copying the write data to a predetermined location in the second persistent memory responsive to the detecting, the copying performed by the controller and responsive to the detecting.

18. The computer program product of claim 17, wherein the write requestor is an application executing on a processor, the CPU load storable memory is memory mapped to the application, and the write data is received directly from the application.

19. The computer program product of claim 17, wherein the write requestor is a device driver, the CPU load storable memory is memory mapped to the device driver, and the write data is received directly from the device driver.

20. The computer program product of claim 17, wherein the disk device is a flash memory.
